(19) United States
(12) Patent Application Publication
(10) Pub. No.: US 2018/0063572 A1
(43) Pub. Date: Mar. 1, 2018

(54) METHODS, SYSTEMS, AND MEDIA FOR SYNCHRONIZING MEDIA CONTENT USING AUDIO TIMECODES

(71) Applicant: Google Inc., Mountain View, CA (US)

(72) Inventor: Boris Smus, San Francisco, CA (US)

(21) Appl. No.: 15/246,219

(22) Filed: Aug. 24, 2016

(51) Int. Cl. H04N 21/43; G10L 19/018; H04N 21/439; H04N 21/8547; H04N 21/472

(52) U.S. Cl. CPC H04N 21/4307; G10L 19/018; H04N 21/812; H04N 21/8547; H04N 21/47217; H04N 21/439

(57) ABSTRACT

Methods, systems, and media for synchronizing media content using audio timecodes are provided. In some implementations, the method comprises: identifying, using a secondary device, a media content item that is being presented on a primary device; detecting, using the secondary device, a tone embedded within a portion of audio content of the media content item; identifying, using the secondary device, a current playback position of the media content item on the primary device based on the detected tone; determining, using the secondary device, supplemental content relevant to the media content item at the current playback position; and causing the supplemental content to be presented on the secondary device.

### TECHNICAL FIELD

The disclosed subject matter relates to methods, systems, and media for synchronizing media content using audio timecodes.

### BACKGROUND

Users often watch movies or television programs on one device while interacting with a second device, such as a mobile phone or a tablet computer. These users may enjoy receiving supplemental content that is relevant to the content they are watching, such as trivia information about actors appearing in the content, an identification of a song being played in the content, and/or information about products appearing in the content on the second device while they are watching the content on the first device. However, it can be difficult to identify the relevant supplemental content and a suitable time to present such content.

Accordingly, it is desirable to provide methods, systems, and media for synchronizing media content using audio timecodes.

### SUMMARY

Methods, systems, and media for synchronizing media content using audio timecodes are provided.

In accordance with some implementations of the disclosed subject matter, a method for supplementing media content is provided, the method comprising: identifying, using a secondary device, a media content item that is being presented on a primary device; detecting, using the secondary device, a tone embedded within a portion of audio content of the media content item; identifying, using the secondary device, a current playback position of the media content item on the primary device based on the detected tone; determining, using the secondary device, supplemental content relevant to the media content item at the current playback position; and causing the supplemental content to be presented on the secondary device.

In some implementations, the supplemental content includes information about an actor included in the media content item at the current playback position.

In some implementations, the supplemental content includes an advertisement.

In some implementations, the tone embedded within the portion of audio content is in an inaudible frequency range.

In some implementations, identifying the supplemental content comprises querying a database with the identifier of the media content item and an indication of the current playback position.

In some implementations, the portion of audio content includes an audio track associated with the media content item and the method further comprises receiving, at the secondary device, a mapping that specifies a plurality of playback positions each corresponding to one of a plurality of tones embedded in the audio track, wherein identifying the current playback position is based on the mapping.

In some implementations, the method further comprises determining that presentation of the media content item on the primary device has been paused by detecting that an expected tone of the plurality of tones indicated in the mapping has not been detected within a given period of time.

In some implementations, the media content item is identified based on a sequence emitted by the primary device that encodes an identifier of the media content item and is detected by the secondary device.

In accordance with some implementations of the disclosed subject matter, a system for supplementing media content is provided, the system comprising a hardware processor that is configured to: identify a media content item that is being presented on a primary device; detect a tone embedded within a portion of audio content of the media content item; identify a current playback position of the media content item on the primary device based on the detected tone; determine supplemental content relevant to the media content item at the current playback position; and cause the supplemental content to be presented on the secondary device.

In accordance with some implementations of the disclosed subject matter, a non-transitory computer-readable medium containing computer-executable instructions that, when executed by a processor, cause the processor to perform a method for supplementing media content is provided, the method comprising: identifying a media content item that is being presented on a primary device; detecting a tone embedded within a portion of audio content of the media content item; identifying a current playback position of the media content item on the primary device based on the detected tone; determining supplemental content relevant to the media content item at the current playback position; and causing the supplemental content to be presented on the secondary device.

In accordance with some implementations of the disclosed subject matter, a system for supplementing media content is provided, the system comprising: means for identifying a media content item that is being presented on a primary device; means for detecting a tone embedded within a portion of audio content of the media content item; means for identifying a current playback position of the media content item on the primary device based on the detected tone; means for determining supplemental content relevant to the media content item at the current playback position; and means for causing the supplemental content to be presented on the secondary device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show examples of user interfaces for presenting supplemental content in accordance with some implementations of the disclosed subject matter.

FIG. 2 shows a schematic diagram of an illustrative system suitable for implementation of mechanisms described herein for synchronizing media content using audio timecodes in accordance with some implementations of the disclosed subject matter.

FIG. 3 shows a detailed example of hardware that can be used in a server and/or a user device of FIG. 2 in accordance with some implementations of the disclosed subject matter.

FIG. 4 shows an example of an information flow diagram for synchronizing media content using audio timecodes in accordance with some implementations of the disclosed subject matter.

FIG. 5 shows an example of a process for synchronizing media content using audio timecodes in accordance with some implementations of the disclosed subject matter.

### DETAILED DESCRIPTION

In accordance with various implementations, mechanisms (which can include methods, systems, and media) for synchronizing media content using audio timecodes are provided.

In accordance with some implementations, the mechanisms can cause a media content item to be presented on a primary device (e.g., a television, a projector, an audio speaker, a desktop computer, etc.) and can cause, at one or more time points, supplemental content relevant to the media content item at the particular time point to be presented on a secondary device (e.g., a mobile phone, a tablet computer, a wearable computer, etc.). In some implementations, the supplemental content can include a quiz relating to the media content item, an identification of a song that is being played in the media content item, trivia information about an actor in the media content item, information about products being presented in the media content item, advertisements, and/or any other suitable supplemental content.

In some implementations, the primary device can emit a sequence when presentation of the media content item begins that encodes an identifier of the media content item. For example, in some implementations, the sequence can be a binary sequence of any suitable length that indicates the identifier. In some implementations, the primary device can detect and decode the sequence to determine an identifier of the media content item. The identifier can then subsequently be used to identify relevant supplemental content.

In some implementations, the mechanisms can cause one or more auditory tones to be embedded within an audio track of the media content item, which can be emitted by the primary device during presentation of the media content item. In some implementations, the secondary device can detect the auditory tones (e.g., via a microphone of the secondary device) and can identify a current playback position of the media content item based on when the tone is detected and a mapping corresponding to the media content item previously received by the secondary device. In some implementations, the secondary device can then query a database with the identifier of the media content item and an indication of the current playback position and can receive supplemental content relevant to the current playback position in response to the query. The secondary device can then cause the supplemental content to be presented. In some implementations, the auditory tones can be at a frequency generally inaudible to human, for example, at a frequency higher than the upper range of audible hearing. In some implementations, any suitable number of tones can be emitted at any suitable time intervals (e.g., at time point specified by a creator of the media content item, at regular periodic time intervals, and/or at any other suitable time intervals).

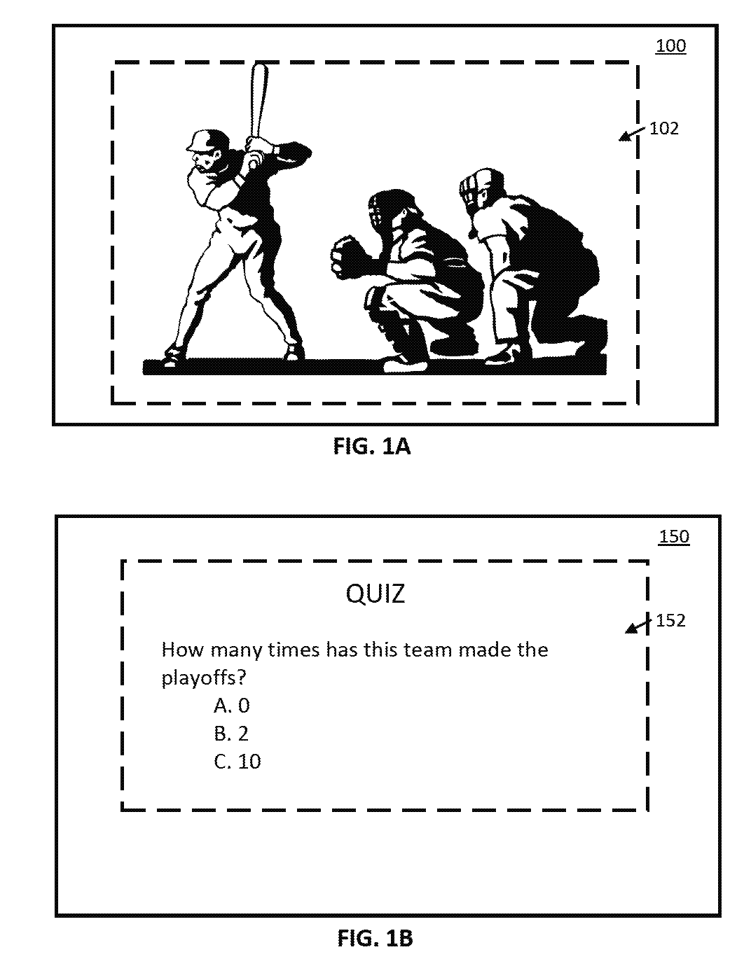

Turning to FIG. 1A, an example 100 of a user interface for presenting content on a primary device (e.g., a television, a projector, an audio speaker, a desktop computer, a laptop computer, and/or any other suitable type of user device) is shown in accordance with some implementations of the disclosed subject matter. For example, as shown in user interface 100, video content 102 can be presented on the primary device. In some implementations, video content 102 can be presented in a video player window that includes controls (e.g., a volume control, a fast-forward control, a rewind control, and/or any other suitable controls) for manipulating presentation of video content 102. In some implementations, video content 102 can be any suitable type of content, such as a video, a television program, a movie, live-streamed content (e.g., a news program, a sports event, and/or any other suitable type of content), and/or any other suitable content. Note that, in some implementations, the content presented on the primary device can be audio content, such as music, an audiobook, a live-streamed radio program, a podcast, and/or any other suitable type of audio content.

Turning to FIG. 1B, an example 150 of a user interface for presenting supplemental content on a secondary device that is related to the content being presented on the primary device is shown in accordance with some implementations of the disclosed subject matter. For example, as shown in user interface 150, supplemental content 152 can be a quiz that is related to video content 102 (e.g., trivia related to video content 102, and/or any other suitable type of quiz questions). As another example, in some implementations, supplemental content 152 can indicate a name of a character and/or actor included in the content on the primary device, a name of a song being played in the content on the primary device, and/or any other suitable information related to the content on the primary device. As yet another example, in some implementations, supplemental content 152 can be an advertisement. In a further example, in some implementations, supplemental content 152 can include a different version of the content being presented on the primary device (e.g., an audio-only version of the content, a personalized version of the content based on user preferences associated with the secondary device, etc.).

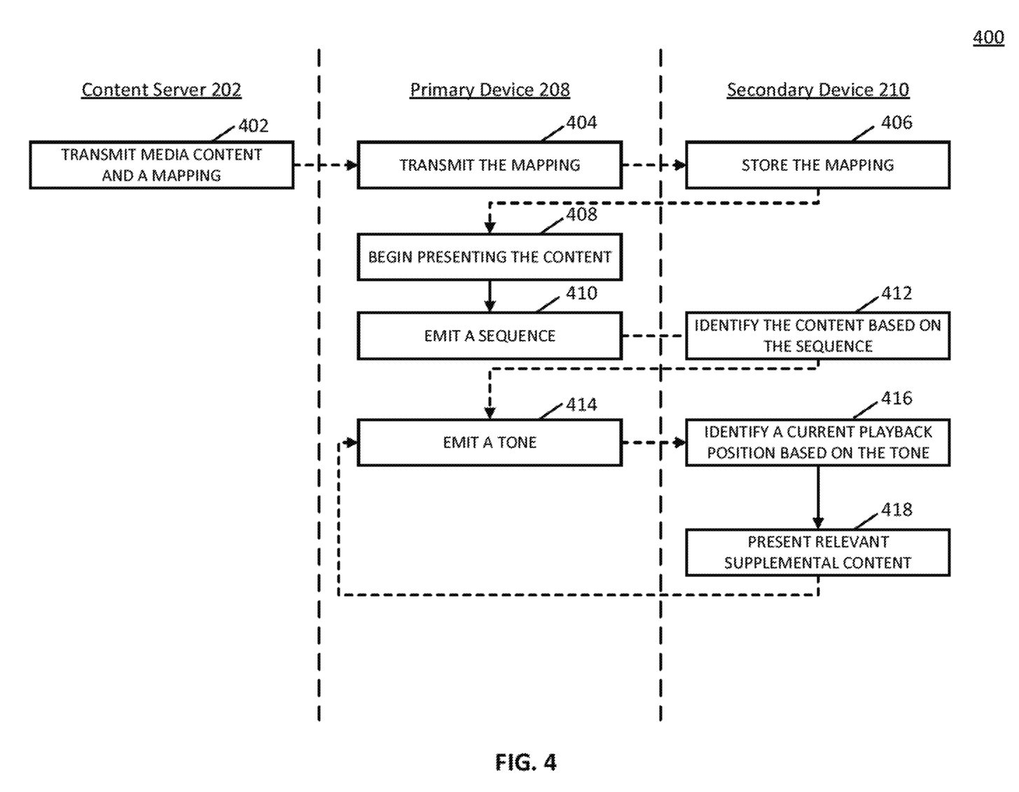

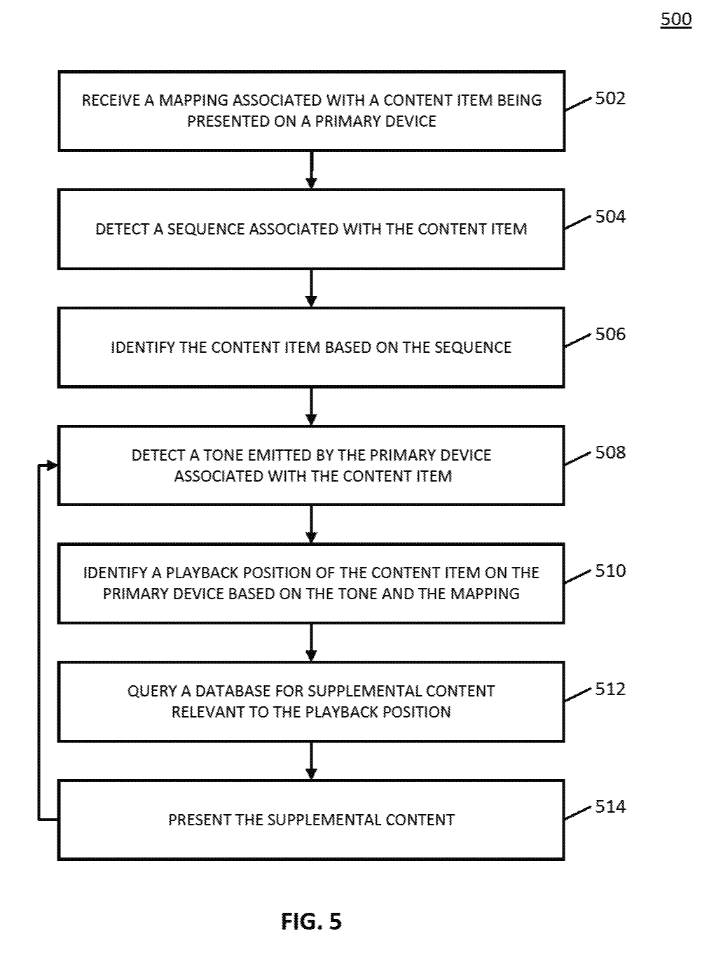

Note that, in some implementations, supplemental content 152 can be synchronized to a time point of video content 102. For example, in some implementations, supplemental content 152 can be presented at a particular time indicated by an auditory tone embedded within an audio track of video content 152, as described below in connection with FIGS. 4 and 5. Additionally, note that techniques for identifying relevant supplemental content are described in more detail in connection with FIG. 5.

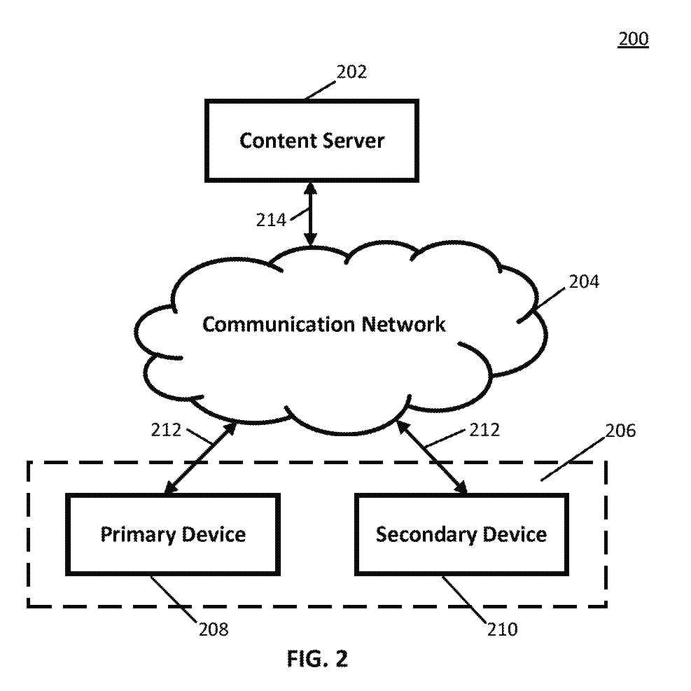

Turning to FIG. 2, an example 200 of hardware for synchronizing media content using audio timecodes that can be used in accordance with some implementations of the disclosed subject matter is shown. As illustrated, hardware 200 can include one or more servers such as a content server 202, a communication network 204, and/or one or more user devices 206, such as user devices 208 and 210.

In some implementations, content server 202 can be any suitable server for storing media content and transmitting the media content to a user device for presentation. For example, in some implementations, content server 202 can be a server that streams media content to user device 206 via communication network 204. In some implementations, the content on content server 202 can be any suitable content, such as video content, audio content, movies, television programs, live-streamed content, audiobooks, and/or any other suitable type of content. In some implementations, content server 202 can be omitted.

Communication network 204 can be any suitable combination of one or more wired and/or wireless networks in some implementations. For example, communication network 204 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 206 can be connected by one or more communications links 212 to communication network 204 that can be linked via one or more communications links (e.g., communications link 214) to content server 202. Communications links 212 and/or 214 can be any communications links suitable for communicating data among user devices 206 and server 202 such as network links, dial-up links, wireless links, hard-wired links, any other suitable communications links, or any suitable combination of such links.

In some implementations, user devices 206 can include one or more computing devices suitable for viewing audio or video content, viewing supplemental content, and/or any other suitable functions. For example, in some implementations, user devices 206 can be implemented as a mobile device, such as a smartphone, mobile phone, a tablet computer, a wearable computer, a laptop computer, a vehicle (e.g., a car, a boat, an airplane, or any other suitable vehicle) entertainment system, a portable media player, and/or any other suitable mobile device. As another example, in some implementations, user devices 206 can be implemented as a non-mobile device such as a desktop computer, a set-top box, a television, a streaming media player, a game console, and/or any other suitable non-mobile device.

In some implementations, user device 206 can include a primary device 208 and a secondary device 210. In some implementations, primary device 208 can present a content item (e.g., a video, audio content, a television program, a movie, and/or any other suitable content). In some implementations, secondary device 210 can present supplemental content that is relevant to the content being presented on primary device 208. For example, in some implementations, secondary device 210 can present information relating to the content item, as described below in connection with FIGS. 4 and 5.

Although content server 202 is illustrated as a single device, the functions performed by content server 202 can be performed using any suitable number of devices in some implementations. For example, in some implementations, multiple devices can be used to implement the functions performed by content server 202.

Although two user devices 208 and 210 are shown in FIG. 2, any suitable number of user devices, and/or any suitable types of user devices, can be used in some implementations.

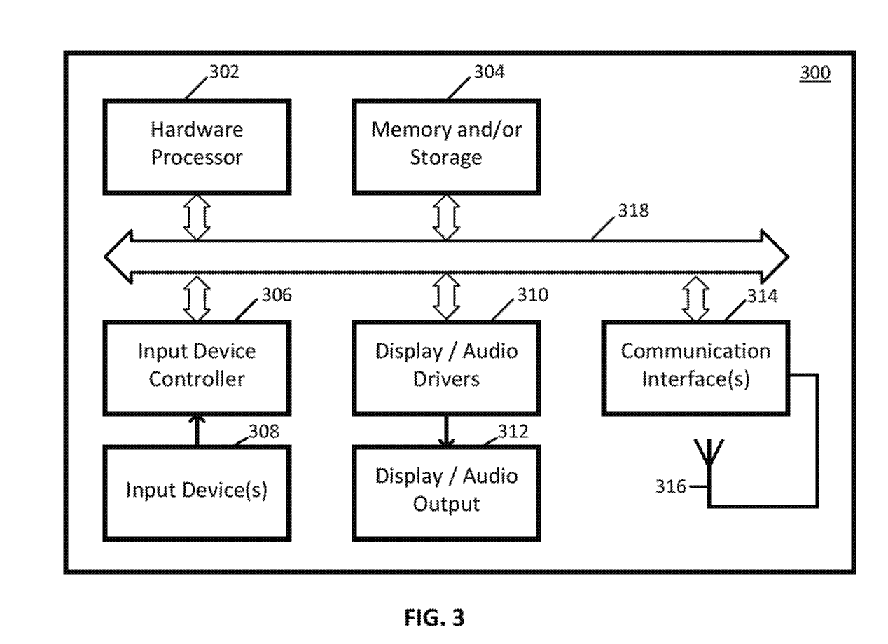

Content server 202 and user devices 206 can be implemented using any suitable hardware in some implementations. For example, in some implementations, devices 202 and 206 can be implemented using any suitable general purpose computer or special purpose computer. For example, a server may be implemented using a special purpose computer. Any such general purpose computer or special purpose computer can include any suitable hardware. For example, as illustrated in example hardware 300 of FIG. 3, such hardware can include hardware processor 302, memory and/or storage 304, an input device controller 306, an input device 308, display/audio drivers 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general purpose computer or a special purpose computer in some implementations. In some implementations, hardware processor 302 can be controlled by a server program stored in memory and/or storage 304 of a server (e.g., such as content server 202). In some implementations, hardware processor 302 can be controlled by a computer program stored in memory and/or storage 304 of primary device 208. For example, the computer program can cause hardware processor 302 of primary device 208 to begin presenting a media content item, emit tones embedded within an audio track of the media content item, and/or perform any other suitable function. In some implementations, hardware processor 302 can be controlled by a computer program stored in memory and/or storage 304 of secondary device 210. For example, in some implementations, the computer program can cause hardware processor 302 of secondary device 210 to detect an auditory tone emitted from primary device 208, identify a playback position in a media content item corresponding to the detected tone, identify supplemental content relevant to the playback position, present the supplemental content, and/or perform any other suitable functions.

Memory and/or storage 304 can be any suitable memory and/or storage for storing programs, data, media content, advertisements, and/or any other suitable information in some implementations. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some implementations. For example, input device controller 306 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or any other type of input device.

Display/audio drivers 310 can be any suitable circuitry for controlling and driving output to one or more display/audio output devices 312 in some implementations. For example, display/audio drivers 310 can be circuitry for driving a touchscreen, a flat-panel display, a cathode ray tube display, a projector, a speaker or speakers, and/or any other suitable display and/or presentation devices.

Communication interface(s) 314 can be any suitable circuitry for interfacing with one or more communication networks, such as network 204 as shown in FIG. 2. For example, interface(s) 314 can include network interface card circuitry, wireless communication circuitry, and/or any other suitable type of communication network circuitry.

Antenna 316 can be any suitable one or more antennas for wirelessly communicating with a communication network (e.g., communication network 204) in some implementations. In some implementations, antenna 316 can be omitted.

Bus 318 can be any suitable mechanism for communicating between two or more components 302, 304, 306, 310, and 314 in some implementations.

Any other suitable components can be included in hardware 300 in accordance with some implementations.

Turning to FIG. 4, an example 400 of an information flow diagram for synchronizing media content using audio timecodes is shown in accordance with some implementations of the disclosed subject matter. As shown, in some implementations, blocks of information flow diagram 400 can be implemented on content server 202, primary device 208, and secondary device 210.

At 402, content server 202 can transmit a media content item and a mapping of auditory tones to time points within the media content item to primary device 208. As described above, in some implementations, the media content item can be any suitable type of media content, such as a video, a movie, a television program, a song, an audiobook, a podcast, live-streamed content, and/or any other suitable type of content. Additionally, in some implementations, content server 202 can transmit a collection of media content items, such as a playlist of songs and/or videos, and/or any other suitable type of collection. Note that, in some implementations, the auditory tones can be embedded within an audio track (or any other suitable portion of audio content) of the media content item.

In some implementations, content server 202 can transmit the media content item and the mapping in response to any suitable information. For example, in some implementations, content server 202 can transmit the media content item and the mapping in response to receiving a request for the media content item from primary device 208.

In some implementations, the mapping can include any suitable information. For example, in some implementations, the mapping can indicate time points associated with one or more auditory tones that will be emitted during presentation of the media content item. As a more particular example, in some implementations, the mapping can indicate a first time that a first auditory tone will be emitted, a second time that a second auditory tone will be emitted, etc. A specific example of a mapping is: [ID1: 5 s; ID2: 10 s; ID3: 13 s], which can indicate that a first auditory tone will be emitted five seconds into the presentation of the media content item, a second auditory tone will be emitted ten seconds into the presentation of the media content item, and a third auditory tone will be emitted thirteen seconds into the presentation of the media content item. Note that, in some implementations, any suitable number (e.g., one, two, five, ten, and/or any other suitable number) of auditory tones can be indicated in the mapping.

At 404, primary device 208 can transmit the received mapping to secondary device 210. In some implementations, primary device 208 can emit a sequence that encodes information indicating the mapping, for example, as a series of tones. As a more particular example, in some implementations, the information indicating the mapping can be encoded within the series of tones in any suitable manner, such as through amplitude or frequency modulation, and/or in any suitable manner. In some implementations, any suitable scheme can be used to encode the information, such as Chirp Spread Spectrum (CSS), Direct Sequence Spread Spectrum (DSSS), Dual Tone Multi-Frequency (DTMF), and/or any other suitable scheme.

At 406, secondary device 210 can store the mapping received from primary device 208 for use when primary device 208 is presenting the media content item. In some implementations, secondary device 210 can store the mapping in any suitable location, such as memory 304 of secondary device 210.

At 408, primary device 208 can begin presenting the media content item. For example, in instances where the media content item includes video content, primary device 208 can begin presenting the video content on a display associated with primary device 208. In a more particular example, a user of primary device 208 can select the media content item from multiple media content items that are available for presentation from a content source and, in response to receiving the selection, the selected media content item can be presented on a display associated with primary device 208. In another more particular example, a user of secondary device 210 can select the media content item from multiple media content item that are available for presentation from a content source and, in response to receiving the selection, the selected media content item can be presented on a display associated with primary device 208 (e.g., via a streaming or casting option). As another example, in instances where the media content item includes audio content, primary device 208 can begin presenting the audio content on speakers associated with primary device 208. An example of a user interface that can be used to present the media content item on primary device 208 is shown in and discussed above in connection with FIG. 1A.

At 410, primary device 208 can emit a sequence that indicates an identity of the media content item. For example, in some implementations, the sequence can be a binary sequence of any suitable length that indicates an identifier of the media content item. In some implementations, the sequence can be in any suitable format, such as auditory tones at any suitable frequency and/or modulation, and/or in any other suitable format. In some implementations, any suitable scheme can be used to encode the identifier of the media content item within a sequence of auditory tones, such as CSS, DSSS, DTMF, and/or any other suitable scheme. Note that, in some implementations, the sequence can be embedded in an audio track of the media content item. For example, in some implementations, the sequence can be at a beginning portion of the audio track such that the sequence is emitted at the beginning of presentation of the media content item.

At 412, secondary device 210 can detect the sequence and can identify the media content item based on the sequence. Secondary device 210 can use any suitable technique or combination of techniques to identify the media content item. For example, in some implementations, secondary device 210 can decode the sequence to determine a corresponding identification number. These and other techniques for identifying the media content item based on the sequence are described below in connection with block 506 of FIG. 5.

At 414, primary device 208 can emit an auditory tone embedded within an audio track of the media content item. In some implementations, the auditory tone can be at any suitable frequency and intensity. For example, in some implementations, the auditory tone can be at a frequency that is generally inaudible to human ears (e.g., above 19 kHz, and/or at any other suitable frequency). In some implementations, the tone can be of any suitable duration (e.g., 500 milliseconds, 1 second, and/or any other suitable duration). Note that, in some implementations, in instances where multiple tones are inserted into the media content item, the tones can be inserted at arbitrary times (e.g., selected by a creator of the content item, selected by a host of the content item, and/or selected by any other suitable entity) and/or inserted at periodic intervals (e.g., every five seconds, every ten seconds, and/or at any other suitable interval). Additionally or alternatively, in some implementations, the tones can be inserted at positions within the media content item where the audio track is particularly loud, thereby reducing the salience of the tone to a viewer of the media content item.

At 416, secondary device 210 can detect the auditory tone emitted by primary device 208 (e.g., using a microphone associated with secondary device 210) and can identify a current playback position of the media content item on primary device 208 based on the auditory tone and the mapping received at block 406. For example, in some implementations, secondary device 210 can determine a number of auditory tones that have been detected (e.g., since the sequence was received at block 412, and/or over any other suitable time period), and can locate the corresponding time point in the mapping. As another example, in instances where information indicating a particular time offset is encoded within the tone using a particular scheme (e.g., CSS, DSSS, DTMF, and/or any other suitable scheme), secondary device 210 can decode a control signal encoded by the tone to determine the time offset. More detailed techniques for identifying the playback position are described below in connection with block 510 of FIG. 5.

At 418, secondary device 210 can identify and present supplemental content relevant to the identified playback position. For example, as shown in and discussed above in connection with FIG. 1B, secondary device 210 can identify and present a quiz related to content currently being presented on primary device 208. As another example, in some implementations, the supplemental content can be information related to content currently being presented on primary device 208, such as a name of a song being played, a name of an actor and/or character included in video content being presented on primary device 208, a name and/or location of a shop that sells a product being featured in the content, and/or any other suitable supplemental content. As yet another example, in some implementations, the supplemental content can include an advertisement. As a more particular example, in some implementations, the advertisement can be specified by any suitable entry, such as a creator of the media content item being presented on primary device 208, a host of the media content item being presented on primary device 208 (e.g., a video sharing service that stores the media content item, a social networking service on which a link to the media content item was posted, and/or nay other suitable service), and/or any other suitable entity.

In some implementations, after presenting the supplemental content on secondary device 210, information flow diagram can loop back to block 414 when another auditory tone is emitted.

Turning to FIG. 5, an example of a process 500 for synchronizing media content using audio timecodes is shown in accordance with some implementations of the disclosed subject matter. In some implementations, blocks of process 500 can be executed on secondary device 210.

Process 500 can begin by receiving a mapping associated with a media content item at 502. As described above, in some implementations, the mapping can indicate a time point during playback of the media content item at which an auditory tone is embedded. For example, in some implementations, the mapping can indicate that a first auditory tone is embedded two seconds into the media content item, that a second auditory tone is embedded five seconds into the media content item, etc. A specific example of a mapping is: [ID1: 5 s; ID2: 10 s; ID3: 13 s], which can indicate that a first auditory tone will be emitted five seconds into presentation of the media content item, a second auditory tone will be emitted ten seconds into presentation of the media content item, and a third auditory tone will be emitted 13 seconds into presentation of the media content item. Note that, in some implementations, the mapping can indicate any suitable number (e.g., one, two, five, ten, twenty, and/or any other suitable number) of auditory tones. Additionally, note that, in some implementations, the time points within the media content item can be specified in any suitable manner, such as minutes/seconds, a frame number, and/or any other suitable format.

Process 500 can receive a sequence associated with the media content item at 504. In some implementations, the sequence can be transmitted by primary device 208 when primary device 208 initiates presentation of the media content item. In some implementations, the sequence can indicate an identifier of the media content item. For example, in some implementations, the sequence can be a binary sequence of any suitable length that indicates the identifier of the media content item.

In some implementations, the sequence can be transmitted in any suitable manner. For example, in some implementations, the sequence can be an auditory sequence emitted by primary device 208 that encodes an identifier of the media content item. As a more particular example, in some implementations, the sequence can be a tone or sequence of tones at any suitable frequency or frequencies that encodes the identifier. In some such implementations, modulations within the tones can encode information indicating the identifier. Specific examples of schemes for encoding the identifier can include: Chirp Spread Spectrum (CSS), Direct Sequence Spread Spectrum (DSSS), Dual Tone Multi-Frequency (DTMF), and/or any other suitable schemes. In some implementations, the tones can be at a frequency that is generally inaudible to humans (e.g., above 19 kHz, and/or at any other suitable frequencies). In some implementations, the sequence can be received in any suitable manner by secondary device 210. For example, in instances where the sequence is transmitted via auditory tones, the sequence can be received by a microphone associated with secondary device 210.

Note that, in some implementations, secondary device 210 can identify the media content item once presentation begins on primary device 208 in any other suitable manner. For example, in some implementations, primary device 208 can identify the media content item by identifying an audio fingerprint associated with a portion of the media content item that has been presented and querying a database to identify the media content item based on the audio fingerprint. As a more particular example, in some implementations, the audio fingerprint can include a portion of the audio content presented by primary device 208 recorded by a microphone of secondary device 210. As another example, in some implementations, primary device 208 can identify the media content item by identifying a video fingerprint associated with a portion of the media content item that is being presenting on primary device 208 and querying a database to identify the media content item based on the captured video fingerprint. As a more particular example, in some implementations, the video fingerprint can include a still image and/or a video recorded by a camera of secondary device 210.

Process 500 can then identify the media content item based on the sequence at 506. For example, in some implementations, process 500 can decode the sequence to determine an identifier associated with the media content item. In some implementations, the identifier can indicate a particular episode of a television program or podcast, a particular version of a movie or video, and/or any other suitable identifying information.

At 508, process 500 can receive, at secondary device 210, a tone emitted by primary device 208 during presentation of the media content item. In some implementations, the tone can be captured by a microphone associated with secondary device 210. Note that, in some implementations, any suitable duration of time may have elapsed between receipt of the sequence at block 504 and receipt of the tone at block 508. In some implementations, the tone can be at any suitable frequency and of any suitable duration. For example, in some implementations, the tone can be at a frequency generally inaudible to humans (e.g., above 19 kHz, and/or at any other suitable frequencies).

At 510, secondary device 210 identify a playback position of the media content item being presented on primary device 208 based on the detected tone and the mapping received at 502. For example, in instances where information indicating a particular time offset is encoded within the tone using a particular scheme (e.g., CSS, DSSS, DTMF, and/or any other suitable scheme), secondary device 210 can decode a control signal encoded by the tone to determine the time offset. As a more particular example, in some implementations, the control signal can explicitly indicate a playback position or time offset at which the tone was presented. As another more particular example, in some implementations, the control signal can encode an identifier, which can be used as a lookup key in the mapping to determine a corresponding playback position. As a specific example, if the mapping is: [ID1: 5 s; ID2: 10 s; ID3: 13 s], and the control signal encodes the identifier “ID2,” process 500 can determine that the playback position is 10 seconds.

As another example, in some implementations, secondary device 210 can determine a number of tones that have been received in association with presentation of the media content item (e.g., that the tone received at block 508 was the first tone, and/or any other suitable number) and can determine a playback position that corresponds to the tone number. As a more particular example, in instances where the mapping is: [ID1: 5 s; ID2: 10 s; ID3: 13 s], and secondary device 210 determines that the detected tone is the second tone detected in connection with presentation of this media content item, process 500 can determine that the current playback position is 10 seconds.

Note that, in some implementations, process 500 can interpolate between detected tones to determine intermediate playback positions. For example, in the specific mapping example shown above, in instances where process 500 determines that one second has passed since the second tone was detected, process 500 can determine that a current playback position is 11 seconds. Note that, in some implementations, process 500 can assume that once presentation of the media content item has begun, presentation of the media content item continues without pause. In some such implementations, secondary device 210 can verify that primary device 208 has not paused presentation of the media content item by determining whether audio content is still detectable on a microphone associated with secondary device 210. Additionally or alternatively, in some implementations, secondary device 210 can verify continued presentation of the media content item by verifying that tones are detected at all of the positions indicated in the received mapping, and, if an expected tone is not detected at the expected playback position, can determine that presentation of the media content item has been paused prior to the expected playback position. Note that, in some implementations, when secondary device 210 determines that presentation of the media content item has been paused, secondary device 210 can continue storing the mapping for use in an instance where presentation of the media content item on primary device 208 resumes.

At 512, process 500 can query a database for supplemental content relevant to the media content item at the determined playback position. For example, as shown in and described above in connection with FIG. 1B, in some implementations, the supplemental content can be a quiz related to trivia associated with a current moment in the media content item. As another example, in some implementations, the supplemental content can indicate an identity of a song that is currently being played in the media content item, information about an actor and/or a character currently appearing in the media content item (e.g., a name of an actor portraying the character, trivia information about the actor, a link to a website about the actor, and/or any other suitable information). As yet another example, in some implementations, the supplemental content can indicate information about a product or item currently being shown in the media content item. As a more particular example, in instances where a particular product is being used (e.g., a particular model of an appliance, a particular model of a car, and/or any other suitable type of product) is being used by a character in a movie, video, or television program, the supplemental content can identify the particular product and can, in some implementations, provide information indicating stores which sell the particular product (e.g., links to online stores, directions to physical stores near a viewer of the content, and/or any other suitable information). As still another example, in some implementations, the supplemental content can be one or more advertisements.

In some implementations, the supplemental content can include any suitable type of content or combination of types of content. For example, in some implementations the supplemental content can include any suitable combination of images, graphics, icons, animations, videos, text, and/or hyperlinks.

Process 500 can identify the supplemental content using any suitable technique or combination of techniques. For example, in some implementations, process 500 can query a database and can include the identifier of the media content item and an indication of the current playback position in the query. The database can then return the supplemental content relevant to the current playback position of the media content item to secondary device 210. Note that, in some implementations, process 500 can use any other suitable information to identify the supplemental content. For example, in instances where process 500 determines that a user of secondary device 210 has previously engaged with the supplemental content when it includes a quiz, process 500 can determine that the supplemental content is to include a quiz. As another example, in instances where process 500 determines that more than a predetermined duration of time has passed since an advertisement has been presented, process 500 can determine that the supplemental content is to include an advertisement. As yet another example, in instances where process 500 determines that supplemental content of a particular type (e.g., links to online stores that sell a particular product, trivia information about an actor in the media content item, and/or any other suitable particular type of supplemental content) is typically dismissed by a user of secondary device 210, process 500 can determine that the supplemental content is not to include content of the particular type typically dismissed by the user.

At 514, process 500 can cause the supplemental content to be presented on secondary device 210. An example of a user interface for presenting the supplemental content is shown in and discussed above in connection with FIG. 1B. Note that, in some implementations, a user of secondary device 210 can interact with the supplemental content. For example, in instances where the supplemental content includes user interface controls for entering selections (e.g., in a quiz) and/or one or more hyperlinks to other pages, the user can select portions of the supplemental content. Additionally or alternatively, in some implementations, the user can dismiss and/or close the supplemental content in any suitable manner. In some implementations, process 500 can automatically close the supplemental content after presentation of any suitable duration (e.g., after a minute, after two minutes, and/or any other suitable duration).

Process 500 can then loop back to block 508 and wait to detect another tone at a different playback position of the media content item. In some implementations, process 500 can terminate in response to determining that presentation of the media content item has finished.

In some implementations, at least some of the above described blocks of the processes of FIGS. 4 and 5 can be executed or performed in any order or sequence not limited to the order and sequence shown in and described in connection with the figures. Also, some of the above blocks of FIGS. 4 and 5 can be executed or performed substantially simultaneously where appropriate or in parallel to reduce latency and processing times. Additionally or alternatively, some of the above described blocks of the processes of FIGS. 4 and 5 can be omitted.

In some implementations, any suitable computer readable media can be used for storing instructions for performing the functions and/or processes herein. For example, in some implementations, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personal information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for synchronizing media content using audio timecodes are provided.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

1. A method for supplementing media content, the method comprising:
receiving a mapping that specifies a plurality of playback positions within a media content item, each of the plurality of playback positions indicating a time point at which one of a plurality of tones included in audio content associated with the media content item will be emitted by a primary device during presentation of the media content item on the primary device;
identifying, using a secondary device, the media content item that is being presented on the primary device;
detecting, using the secondary device, a tone of the plurality of tones embedded within a portion of the audio content of the media content item;
identifying, using the secondary device, a current playback position of the plurality of playback positions of the media content item on the primary device based on the received mapping;
determining, using the secondary device, supplemental content relevant to the media content item at the current playback position; and
causing the supplemental content to be presented on the secondary device.

2. The method of claim 1, wherein the supplemental content includes information about an actor included in the media content item at the current playback position.

3. The method of claim 1, wherein the supplemental content includes an advertisement.

4. The method of claim 1, wherein the tone embedded within the portion of audio content is in an inaudible frequency range.

5. The method of claim 1, wherein determining the supplemental content comprises querying a database with an identifier of the media content item and an indication of the current playback position.

6. (canceled)

7. The method of claim 1, further comprising determining that presentation of the media content item on the primary device has been paused by detecting that an expected tone of the plurality of tones indicated in the mapping has not been detected within a given period of time.

8. The method of claim 1, wherein the media content item is identified based on a sequence emitted by the primary device that encodes an identifier of the media content item and is detected by the secondary device.

9. A system for supplementing media content, the system comprising:
a hardware processor that is configured to:
receive a mapping that specifies a plurality of playback positions within a media content item, each of the plurality of playback positions indicating a time point at which one of a plurality of tones included in audio content associated with the media content item will be emitted by a primary device during presentation of the media content item on the primary device;
identify the media content item that is being presented on the primary device;
detect a tone of the plurality of tones embedded within a portion of the audio content of the media content item;
identify a current playback position of the plurality of playback positions of the media content item on the primary device based on the received mapping;
determine supplemental content relevant to the media content item at the current playback position; and
cause the supplemental content to be presented on the secondary device.

10. The system of claim 9, wherein the supplemental content includes information about an actor included in the media content item at the current playback position.

11. The system of claim 9, wherein the supplemental content includes an advertisement.

12. The system of claim 9, wherein the tone embedded within the portion of audio content is in an inaudible frequency range.

13. The system of claim 9, wherein determining the supplemental content comprises querying a database with an identifier of the media content item and an indication of the current playback position.

14. (canceled)

15. The system of claim 9, wherein the hardware processor is further configured to determine that presentation of the media content item on the primary device has been paused by detecting that an expected tone of the plurality of tones indicated in the mapping has not been detected within a given period of time.

16. The system of claim 9, wherein the media content item is identified based on a sequence emitted by the primary device that encodes an identifier of the media content item and is detected by the secondary device.

17. A non-transitory computer-readable medium containing computer-executable instructions that, when executed by a processor, cause the processor to perform a method for supplementing media content, the method comprising:
receiving a mapping that specifies a plurality of playback positions within a media content item, each of the plurality of playback positions indicating a time point at which one of a plurality of tones included in audio content associated with the media content item that will be emitted by a primary device during presentation of the media content item on the primary device;
identifying the media content item that is being presented on the primary device;
detecting a tone of the plurality of tones embedded within a portion of the audio content of the media content item;
identifying a current playback position of the plurality of playback positions of the media content item on the primary device based on the received mapping;
determining supplemental content relevant to the media content item at the current playback position; and
causing the supplemental content to be presented on the secondary device.
